(19) United States
(12) Patent Application Publication
(10) Pub. No.: US 2022/0122176 A1
(43) Pub. Date: Apr. 21, 2022

(54) SYSTEM AND METHOD FOR TRADING ACROSS MULTIPLE INVESTORS

(71) Applicant: Tradeweb Markets LLC, New York, NY (US)

(72) Inventors: Ian Stocks, Montclair, NJ (US); Christian Adam Bruner, New York, NY (US); Joseph Kimmel, Irvington, NY (US); Iseult Conlin, New York, NY (US); John Tosti, Bradley Beach, NJ (US); Justin Daniel Peterson, New York, NY (US)

(21) Appl. No.: 17/502,271

(22) Filed: Oct. 15, 2021

Related U.S. Application Data
(60) Provisional application No. 63/092,214, filed on Oct. 15, 2020.

(51) Int. Cl. G06Q 40/04

(52) U.S. Cl. CPC G06Q 40/04

(57) ABSTRACT

Disclosed herein are systems and methods that collapse risk in connection with electronic trades. The method includes collecting electronic trades, each electronic trade comprising party information, buy/sell information; determining hedge amounts for buys/sells for the electronic trades based on buy/sell data; simultaneously determining net hedge amounts for market participants; simultaneously determining a net hedge percentage for electronic trades; determining an individual hedge size for one or more first market participants based on a unique umbrella hedge value, wherein the umbrella hedge value for each of the first market participants is the net hedge percentage of said first market participant's net hedge amount; and distributing instructions to the plurality of market participants to fill the plurality of electronic trades at prices controlled by each first market participant's unique umbrella hedge value and by a composite mid-price for a plurality of second market participants.

### CROSS-REFERENCE TO RELATED APPLICATION

This application claims the benefit of Provisional Application Ser. No. 63/092,214, filed Oct. 15, 2020, entitled “System and Method for Trading Across Multiple Investors”, the entire disclosure of which is hereby incorporated by reference.

### BACKGROUND

The embodiments of the present invention relate to unique systems and methods for collapsing risk and sharing savings across multiple investors of spread-quoted financial products and corresponding reference products.

Investors face challenges when trading spread-quoted financial products due to the risks inherent to such trades. Where the financial product is one that is traded with respect to a reference price of a different financial product (“reference product”), an investor may try to oppositely buy or sell the reference product such that the risk presented by the financial product is offset. This is referred to as “hedging”. One such financial product is a spread-quoted bond that is traded with respect to a reference price of a treasury benchmark bond such that the treasury benchmark bond is a reference product. Purchasing (or selling) a bond on spread presents interest rate risks inherent to the corporate bond. In order to attempt to offset those risks, an investor typically will oppositely sell (or purchase) a treasury benchmark bond such that its sale (or purchase) is an offsetting trade. Accordingly, from an investor's point of view, when they buy a spread-quoted bond, they will sell the dollar value of one basis point (“DV01”) equivalent treasury benchmark bond at the bid price, and when an investor sells a spread-quoted bond they will buy the treasury benchmark bond at the offer price. This is traditionally referred to as “treasury hedging”.

When spread-quoted bond products are bought or sold, they are quoted as the yield spread above a benchmark US treasury bond (“treasury”). A treasury benchmark bond price and yield is typically agreed upon by the buyer and seller for the purpose of establishing a spread-quoted bond price. This agreed to price and yield are referred to as the treasury spot and the process of agreeing to the price and yield is referred to as spotting. For other financial products, spotting can be defined as choosing the reference price(s) of any other market-determined inputs that are required, in combination with the quoted level, to determine the final agreed price of the quoted transaction. Because a dealer attempting to hedge the risk presented by the trade of a spread-quoted bond must purchase or sell the treasury benchmark at the prevailing market price, the spot of the spread-quoted bond will reflect the bid-offer spread of the treasury benchmark. For example, when an investor buys a spread-quoted bond, the spread-quoted bond will be spotted at the offer of the treasury benchmark, and when an investor sells, the spread-quoted bond will be spotted at the bid of the treasury benchmark.

As part of traditional spotting processes for multiple trades, separate spots must be executed for each of the spread-quoted bond trades. Not only does this traditional method require resources of the trade participants to acquire multiples spots, it also inherently involves an increased risk of the two spots being different between each trade, which may result in additional costs and risks for an investor.

Trading platforms have been created that spot multiple trades at a single common spot for all dealers, which avoids individualized spotting for each trade and thereby reduces the resources, the risks and costs involved in spotting. Such trading platforms have been described, for example, in U.S. patent application Ser. No. 16/209,836, entitled SYSTEM AND METHOD FOR COMMON SPOTTING ACROSS MULTIPLE DEALERS, which was filed Dec. 4, 2018, the entirety of which is incorporated herein by reference. However, those systems and methods which are inherently optimized for parties that both buy and sell do not provide similar cost savings for parties that are only buying or only selling. Similarly, parties that may offset risk for buys and sells are not afforded the opportunity to offset the residual risk with other parties on the trading platform. Prior art systems provide cost savings for parties that are both buying and selling, such as when an investor is transferring risk from one corporate bond to another, of similar duration, or when buying for one fund and selling for another. As a result of that lack of benefit, trading firms that are only selling or only buying do not spot trades at a common spot because there is little to gain from such spotting.

Accordingly, a need exists for addressing the short comings of existing spotting and hedging processes. One such solution is an automated process of aggregation of trades and netting of reference product spots that can be applied across a firm's financial product transactions and dealer relationships utilizing systems and methods that mediate multiple trades involving multiple investors such that savings result for investors on either side of the trades regardless of whether a party is buying, selling, or both.

In view of the above discussion and the shortcomings in the prior art, the invention seeks to overcome such shortcomings of the prior art by providing technology offerings that ultimately settle multiple trades involving multiple parties by using multiple spots to achieve cost savings for the parties involved regardless of whether a party is buying, selling, or both.

### SUMMARY

Various embodiments of the present invention provide a computer implemented method of collapsing risk in connection with a plurality of electronic trades using a trading system comprising one or more computer systems, whereby the trading system is operative with programming to enable a plurality of market participants buying or selling financial products to execute and hedge the plurality of electronic trades. The method comprises collecting by the trading system electronic trades from each of the plurality of market participants, each electronic trade comprising data representing party information, data representing trade position information; determining hedge amounts for buys and sells for the plurality of electronic trades based on the data representing trade information; simultaneously determining by the trading system one or more net hedge amounts for each of the plurality of market participants; simultaneously determining by the trading system a net hedge percentage for the plurality of electronic trades; simultaneously determining by the trading system an individual hedge size for one or more first market participants from the plurality of market participants based on a unique umbrella hedge value, wherein the umbrella hedge value for each of the one or more first market participants is the net hedge percentage of said first market participant's net hedge amount; and distributing by the trading system one or more instructions to the plurality of market participants to fill the plurality of electronic trades at one or more prices controlled by each first market participant's unique umbrella hedge value and by a composite mid-price for a plurality of second market participants from the plurality of market participants.

In some embodiments the method further comprises determining the one or more prices based at least in part on a weighted average related to a hedge value. In certain embodiments at least one of the plurality of market participants has only buy positions, only sell positions or both buy and sell positions. In one embodiment the plurality of market participants are grouped into pools of investors.

One embodiment provides for a non-transitory computer program product, comprising a computer usable medium having stored therein instructions that, when executed by at least one processor, configure one or more computers of an electronic trading system to collect by a trading system electronic trades from each of a plurality of market participants, each electronic trade comprising data representing party information, data representing trade position information; determine by a trading system hedge amounts for buys and sells a plurality of electronic trades based on the data representing trade information; determine by the trading system one or more net hedge amounts for each of the plurality of market participants; determine by the trading system a net hedge percentage for the plurality of electronic trades; determine by the trading system an individual hedge size for one or more first market participants from the plurality of market participants based on a unique umbrella hedge value, wherein the umbrella hedge value for each of the one or more first market participants is the net hedge percentage of said first market participant's net hedge amount; and distribute by the trading system one or more instructions to the plurality of market participants to fill the plurality of electronic trades at one or more prices controlled by each first market participant's unique umbrella hedge value and by a composite mid-price for a plurality of second market participants from the plurality of market participants.

One embodiment provides for a computer implemented system for collapsing risk in connection with a plurality of electronic trades to enable a plurality of market participants buying or selling financial products to execute and hedge the plurality of electronic trades, the system comprising a trading system comprising one or more computer systems capable of analyzing a plurality of electronic trades and generating instructions including trade orders, the trading system further including one or more account database for storing data representing a plurality of electronic trades; a plurality of user computers each in electronic communication with the trading system, the plurality of user computers including a plurality of dealer computers each comprising an automated dealer trading system capable of sending data to and receiving data from the trading system, and a plurality of market participant computers capable of sending data to and receiving data from the trading system; wherein the trading system is communicatively coupled to the dealer computers, and the market participant computers, and the trading system is operative with programming to collect electronic trades from each of a plurality of market participants, each electronic trade comprising data representing party information, data representing trade position information; determine hedge amounts for buys and sells a plurality of electronic trades based on the data representing trade information; determine one or more net hedge amounts for each of the plurality of market participants; determine a net hedge percentage for the plurality of electronic trades; determine an individual hedge size for one or more first market participants from the plurality of market participants based on a unique umbrella hedge value, wherein the umbrella hedge value for each of the one or more first market participants is the net hedge percentage of said first market participant's net hedge amount; and distribute one or more instructions to the plurality of market participants to fill the plurality of electronic trades at one or more prices controlled by each first market participant's unique umbrella hedge value and by a composite mid-price for a plurality of second market participants from the plurality of market participants.

### BRIEF DESCRIPTION OF THE DRAWINGS

The foregoing as well as the following detailed description of preferred embodiments of the application, will be better understood when read in conjunction with the appended drawings wherein like reference numerals refer to like components. For the purposes of illustrating the system and method of the present application, there is shown in the drawings preferred embodiments. It should be understood, however, that the application is not limited to the precise arrangement, structures, features, embodiments, aspects, and systems shown, and the arrangements, structures, features, embodiments, aspects and systems shown may be used singularly or in combination with other arrangements, structures, features, embodiments, aspects and systems.

The drawings are not necessarily drawn to scale and are not in any way intended to limit the scope of this invention, but merely to clarify a single illustrated embodiment of the invention. In the drawings:

FIG. 1 depicts an exemplary schematic block diagram of a trading platform according to one embodiment of the present invention;

FIGS. 2A, 2B and 2C depict an exemplary Collapsed-Risk Shared-Savings of trades for multiple investors according to one embodiment of the present invention;

FIGS. 3A and 3B depict an exemplary display of the savings obtained by multiple investors according to one embodiment of the present invention; and

FIGS. 4A-D depicts examples of differences in pricing according to one embodiment of the present invention.

### DESCRIPTION OF CERTAIN EMBODIMENTS OF THE INVENTION

In accordance with various embodiments of the invention, and as shown herein, various systems and methods are disclosed that collapse counterparty risk across multiple investors. The systems and methods reduce risk and provide savings to a plurality of parties involved in multiple trades by settling those trades using multiple spot prices, such that benefits are realized regardless of the party's trade position (i.e., whether a party is only buying, only selling, or both). Such system and methods may do so by effectively simultaneously executing the multiple trades as a pooled transaction.

As used herein, an investor may be a market participant who is either buying or selling a financial product from or to one or more dealers, or a market participant who is either buying or selling the financial product while also hedging those trades with trades of an offsetting financial product by using an associated dealer as an intermediary. As used herein, a dealer means an entity representing the trading desk through which an investor is buying or selling a financial product, or an entity that is buying or selling a financial product from or to another dealer. Although some embodiments are described herein in terms of corporate bond trading and corresponding treasury benchmark bond trading, in various embodiments the invention is applicable to all spread-quoted financial products that are traded with respect to a price of another financial product.

In general, a computerized electronic trading system according to certain embodiments of the present invention enables multiple investors that are buying and/or selling spread-quoted financial products to share in the savings that result from the spotting processes by pooling multiple trades, netting the risk across the investors associated with the pooled trades, and determining multiple spot prices such that each investor benefits from being part of the pooled and netted trades regardless of whether they are buying, selling, or both. In certain embodiments the system determines investor specific spots, with each investor receiving either a single spot or multiple spots, such that at least two investors receive different spots. In certain embodiments the system determines spots specific to groups of investors, with each group of investors receiving either a single spot or multiple spots, such that at least two groups of investors receive different spots. In some embodiments the system determines multiple weighted average spots for an investor or a group of investors.

Once the spotting is performed and all of the spread-quoted trades and corresponding off-setting trades have been completed, the trades may be processed at the determined spots as long as each respective spot is acceptable for the respective investor. Interaction between market participants is preferably achieved across an electronic marketplace (i.e., trading platform), which may consist of various computers which run applications dedicated to several functions such as market creation and management (e.g., order book management, market data dissemination, trading protocol management, information storage, etc.). An example of one such trading platform has been described, for example, in U.S. Pat. No. 7,433,842, entitled METHOD AND SYSTEM FOR EFFECTING STRAIGHT-THROUGH-PROCESSING OF TRADES OF VARIOUS FINANCIAL INSTRUMENTS, which issued Oct. 7, 2008 and was filed Mar. 25, 2004 as U.S. patent application Ser. No. 10/808,820, the entirety of which is incorporated herein by reference.

In an exemplary embodiment, the system architecture of the computerized electronic trading system and method includes hardware, system software and application software. The system hardware may include one or more mainframe computers each having at least one processor and memory. The system hardware may additionally include other components such as storage and network components (i.e., servers, routers, switches, data buses, databases, etc.), networked to the mainframe computer and any external connections as would be understood by a person of ordinary skill in the art having the benefits of the present disclosure.

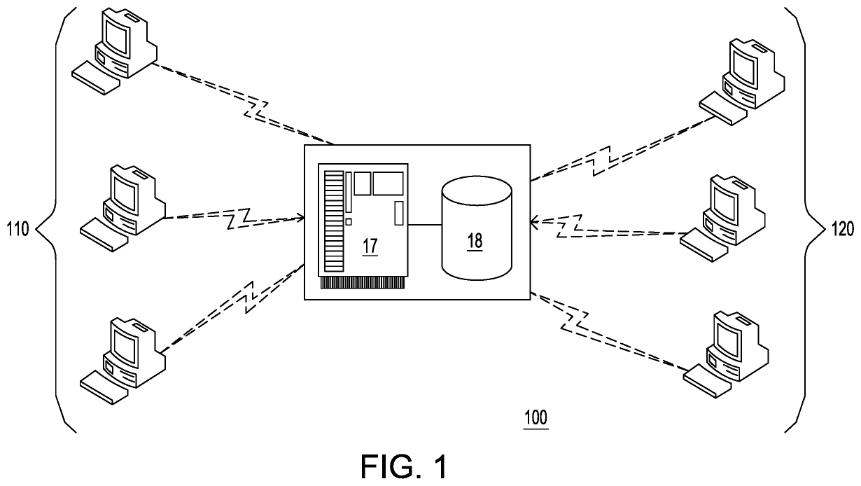

In an exemplary embodiment, a computerized electronic trading system and method includes a central trading system, a trading platform and a plurality of user (investor, dealer) computers through which the investor(s) and dealer(s) may process their trades. For example, FIG. 1 shows an exemplary embodiment of a trading system 100 in communication with various investor computers 110 and dealer computers 120. Trading system 100 preferably includes one or more computer systems 17 that may include one or more software modules, databases 18 and related database management systems. Investor computers 110 may also typically connect to or include an Order Management System (“OMS”) to assist in the execution and trading of securities. Various input and output devices are preferably provided with the investor computers 110 and dealer computers 120 including, by way of non-limiting example, a display (e.g., liquid crystal display (LCD)), and an input device (e.g., a keyboard, mouse, touch pad, or light pen). Preferably, an Application Programming Interface (“API”) is used to connect the dealer and investor to the electronic trading system and perform certain tasks automatically. For example, an API may be utilized by an investor to connect their system with the electronic trading system for the purpose of sending orders which may eventually be converted for the dealer. Dealers may connect to the central trading system via an API for the purpose of providing the trading system with information, for example by having an automated dealer trading system communicatively coupled to the central trading system. The investor and dealer computers 110 and 120 also preferably include a storage device such as, for example, a magnetic disk drive and magnetic disk or other equivalent device. The specific hardware combination/configuration is not crucial to the instant invention, and may vary as a matter of design choice within the functional parameters disclosed herein. Users (dealers and investors) of the trading system 100 typically interact with the Graphical User Interfaces (“GUI's”) displayed by the software modules by “clicking” on numbers or graphics (e.g., buttons) that are displayed on the GUI's. Persons of skill will understand that the present invention is not limited to clicking with a computer mouse, but includes use of any other device for indicating an action with graphics-based software.

According to one embodiment of the present invention, investors and dealers follow the below described process to complete their trades as part of a collapsed-risk shared-savings (“CRSS”) transaction. In one embodiment of the present invention spotting for a trade that is part of a CRSS transaction is completely automated through one or more computer systems 17. The system identifies trades that are available for spotting, or spotting and hedging, in a CRSS transaction (“CRSS-available”) and can deliver a hedge that links the hedge price with the spot price. In various embodiments trades can be CRSS-available for any number of reasons, such as, for example after an electronic trade of a spread-quoted financial product (“SQFP”), such as a corporate bond, has been agreed to at a corresponding reference product price and yield, and a dealer or investor desires to hedge those trades with equivalent reference product (“ERP”) trades, such as treasury bonds, in which case an investor may designate the trades for potential spotting within a CRSS transaction as being CRSS-available. An investor may designate one or more specific SQFP trades as CRSS-available. An investor may specifically designate one or more specific ERP trades as CRSS-available. An investor may designate multiple SQFP trades, ERP trades, or both as CRSS-available such that the investors desire the trades to be spotted, or spotted and hedged, as part of the same CRSS transaction. Dealers may elect to have some (such as trades of specific SQFPs and/or ERPs) or all of their SQFP and/or ERP trades designated as CRSS-available; and/or certain trades may be pre-identified by the system as CRSS-available such that the trades' CRSS-availability is locked. In some embodiments, CRSS-available trades can be scheduled for part of a CRSS transaction at selected or pre-set times, for example by the user and/or the system. As can be appreciated by one of ordinary skill in the art, designating trades to be spotted, or spotted and hedged, as part of a CRSS transaction may be performed automatically without any required human interaction, for example based on pre-set user settings which may include a particularly scheduled time. In various embodiments of the present invention, initially to facilitate the spotting process, an investor or a group of investors may designate specific trades as CRSS-available, and/or a dealer or a group of dealers makes such a designation, in each case by utilizing a specialized GUI. In some embodiments, the party to a SQFP or ERP trade that is selling the SQFP or ERP is the party that may designate the SQFP as CRSS-available. In some embodiments, the party to the SQFP or ERP trade that is buying the SQFP or ERP is the party that may designate the SQFP or ERP trade as CRSS-available. CRSS-available trades are then automatically collected by the trading system for potential inclusion in a CRSS transaction. In one embodiment, a user of the system may establish defaults or other criteria for automated designation of trades as CRSS-available. The system may then simultaneously spot, or spot and hedge, each of the CRSS-available trades selected by the system for inclusion in a CRSS such that each party to the trades involved in the CRSS transaction shares in the resulting savings, as will be discussed in more detail below.

One embodiment of the present invention is a computer implemented electronic trading system which simultaneously spots multiple trades between multiple parties by collecting CRSS-available trades, determining CRSS-eligibility of each CRSS-available trade, determining a net-hedge level, and determining a spot for each of the multiple trades where the hedge and spot price are linked. The system automatically collects CRSS-available trades, for example trades that have been designated as CRSS-available by an involved investor or dealer. Preferably each CRSS-available electronic trade includes data representing SQFP information, ERP information, and party information. Numerous parties (dealers and investors) may be involved in a CRSS transaction involving numerous trades. For example, in one embodiment, the systems and methods of the present invention may simultaneously create multiple spots for use in multiple trades of corporate bonds and multiple trades of treasury benchmark bonds between a plurality of parties made up of eighteen investors (twelve of which are hedging) and nine dealers. It should be understood that these numbers of trades, dealers and investors simply serves as an example and should not be understood as limiting.

Once the system has collected CRSS-available trades, the system determines the risk of each trade. In some embodiments, the system groups the CRSS-available trades according to the ERP (for example, the equivalent treasury benchmark) for each trade, such that grouped trades have the same ERP. In some embodiments the system then calculates the DV01 equivalent reference product hedge quantity (“ERP Quantity”, also referred to as “ERP risk”) for each trade by utilizing a ERP Market Price obtained or calculated by the system. The ERP Market Price may for example be a prevailing ERP Composite Price for a ERP. For instance where the SQFP trades are for spread-quoted bonds, the system may aggregate treasury prices from automated trade systems of multiple dealers that are communicatively coupled to the system, analyze Treasury pricing feeds from dealers over a period of time, analyze Treasury trades that have occurred on the trading platform of the system, or other price source, or use the Treasury price at which the parties agreed to the collected spread-quoted bond trades. ERP price information (for example, Treasury price information) may be within the electronic trade data as part of the spread-quoted bond information.

In certain embodiments, once the system has determined ERP Risk for each CRSS-eligible trade, the system may automatically determine CRSS-eligibility based on CRSS criteria. For all trades satisfying the CRSS criteria, the system then aggregates the ERP Risk of each investor (“Net Risk”). The system can then execute the Net Risk in the market. The net risk is then taken by the intermediating dealer and distributed out to each dealer being auto-hedged within the CRSS, and SQFP trades are spotted at prices determined for the purchases (“buys”) and sales (“sells”) of a set of SQFP trades. The system may use any logic to determine those spot prices, including, but not limited to, using prices of investor specific umbrella hedges, or using two different prices (for buys and sells) for hedges and spots depending on side of the transaction (e.g., whether an investor's net position is buying or selling), or utilizing balanced net spotting as described in more detail below.

In some embodiments spot prices are determined by using investor specific umbrella hedges. To do so, the system calculates the Net Risk tolerated by each investor. An investor may have multiple trades to be spotted, or spotted and hedged, within a CRSS transaction. The system then calculates the Net Risk of the CRSS by summing all risk across all eligible investor pools. The system compares the Net Risk of each investor with the CRSS Net Risk. For each investor that has Net Risk in the opposite direction of the Net CRSS Risk, the system spots and hedges all of their trades at the composite mid. For each investor that has Net Risk in the same direction of the CRSS Net Risk, the system reduces each such investor's Net Risk to execute their trades as an “umbrella hedge”, and does so proportionally based on reduction of the CRSS risk after netting together investors' pools. The system then executes those umbrella hedges, and the prices for the involved spots and hedges are calculated from the price of the execution of the umbrella hedge and the price of where risk was internalized at the “composite mid”. As a result, each investor is independently spotted and/or hedged such that there is no dependency on others to spot or hedge their trades independently. In alternative embodiments, for each investor with Net Risk in the opposite direction of the Net CRSS Risk, the system determines spot prices based on the CRSS mid which is calculated based on all of the execution prices for the umbrella hedges of investors having Net Risk in the same direction of the Net CRSS Risk.

For example, in one embodiment to enable balanced net spotting, a composite bid and offer is established that will be used for all further calculations related to arriving at an equitable price for all participants. First the platform hedge amount for buy and sell direction is calculated for a given benchmark (e.g., 200 mm to buy, 250 mm to sell). The net hedge amount is then calculated (e.g., 250 mm-200 mm=50 mm to sell). Using the net hedge amount, the hedge percentage can then be calculated (e.g., 50 mm/250 mm=20%). Individual hedge sizes for each investor utilizing umbrella hedges can then be calculated (e.g., 20% of 50 mm to sell for investor A=10 mm request). In other words an umbrella hedge (or the value that the platform aims to get for the investor) is the hedge percentage of the investor's original net hedge amount. In one embodiment additional rounding may take place.

In one embodiment the following formulas are utilized to calculate the pricing for buys and sells. The mid-price is calculated based on the actual execution price+/−half of the composite width mentioned above. The balanced price is then calculated based on a weighted average of the umbrella hedge and the amount “executed” at the original composite mid (as described in more detail below).

If an umbrella hedge is done at the composite price, the price move is simply calculated by the moveRatio where Sz=size and Px=price.

$$MoveRatio = \frac{{Sz}_{LargerRisk} - {Sz}_{umbrella}}{{Sz}_{LargerRisk}}$$

$$RiskRatio = \frac{{Sz}_{SmallerRisk}}{{Sz}_{LargerRisk}}$$

$${Px}_{Move} = MoveRatio * \frac{width}{2} + ( MoveRatio - RiskRatio ) * \pm ( {Px}_{Umbrella} - {Px}_{Composite} )$$

In the event that the calculated Bid spot is greater than the calculated offer spot (i.e. it is inverted), which may occur if an umbrella price is significantly worse (i.e., lower for Net Sells/higher for Net Buys) than the composite price, a single Mid could be used as calculated by the following formula (where Sz=size and Px=price):

$${Comp}_{Mid} ∓ \frac{\begin{matrix}{Px}_{Umbrella} \pm {Comp}_{Mid} \pm \\ ( \begin{matrix}MoveRatio * \frac{width}{2} + \\ MoveRatio * \pm ( {Px}_{Umbrella} - {Px}_{Composite} )\end{matrix} )\end{matrix}}{1 - RiskRatio}$$

Use of these formulas determines how much the price is moved to determine a spot.

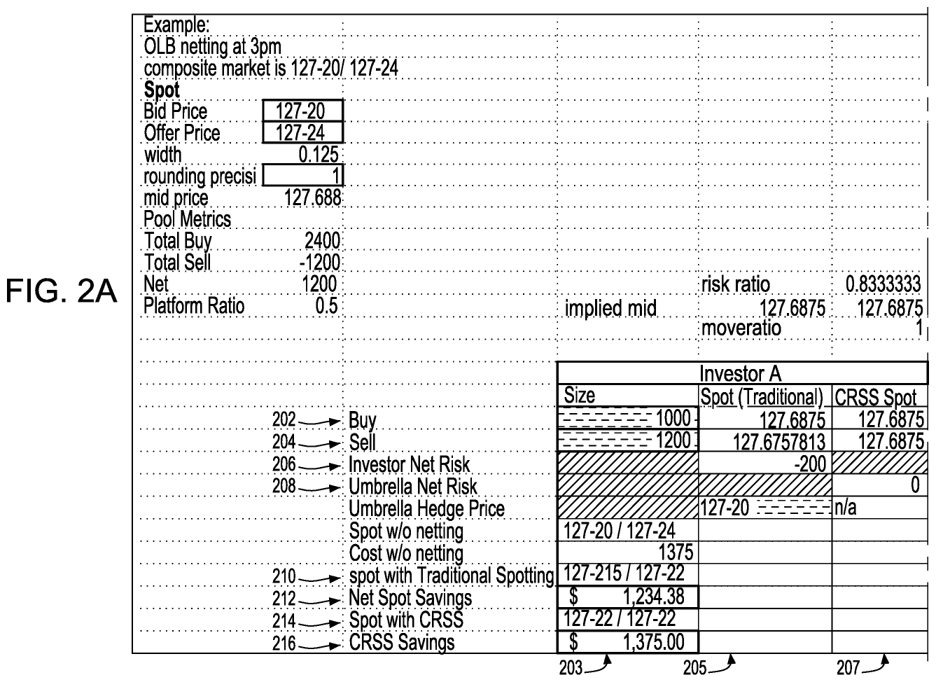

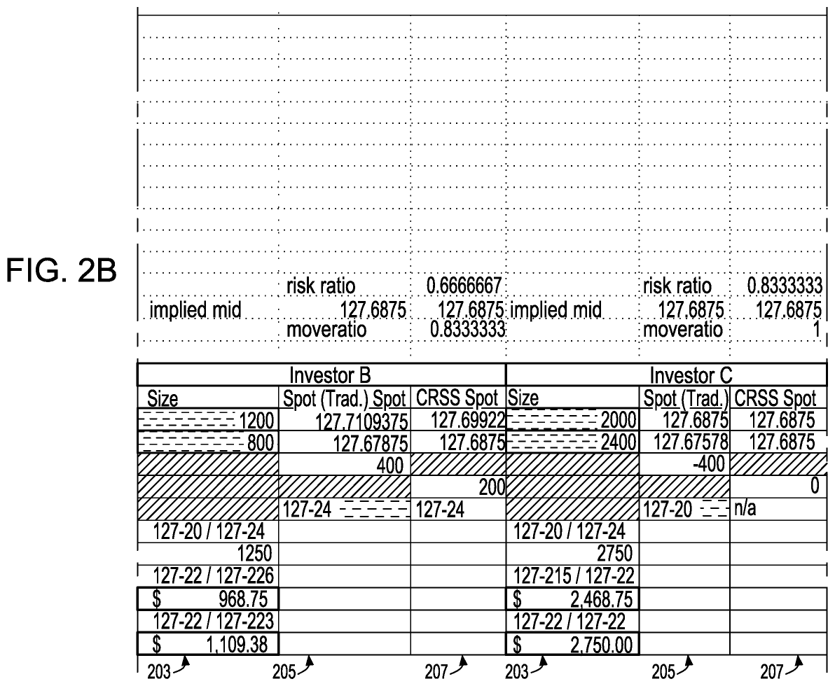

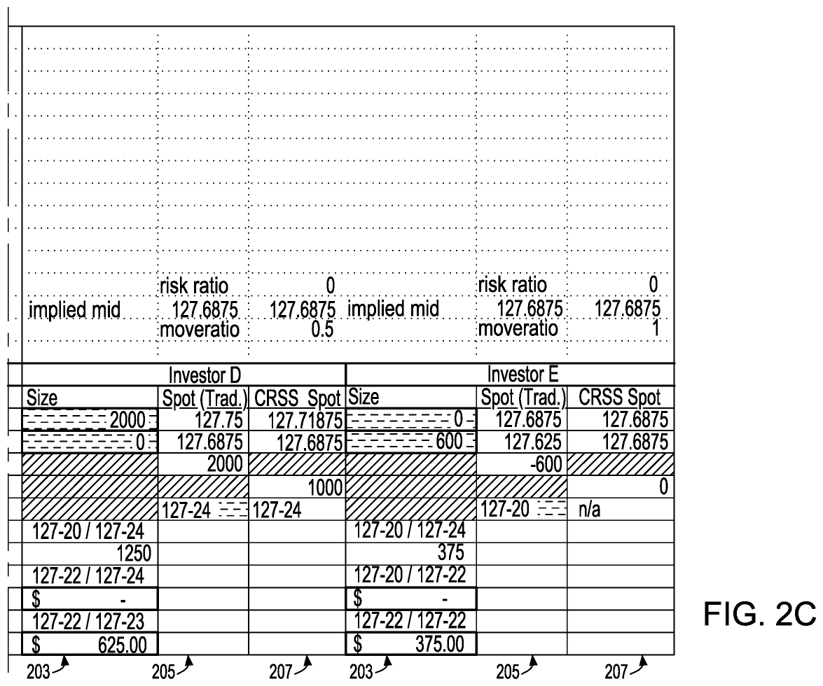

With reference to FIGS. 2A-2C, an illustrative embodiment using the above formulas is described below. Following collection of CRSS-available trades, and determining CRSS-eligibility, the system groups Investors A, B, C, D and E for a CRSS transaction. For each Investor, the system determines the net treasury risk, which is shown in row 206 titled “Investor Net Risk”. The System then calculates the net CRSS risk by summing all of those risks—“Total Buy” (2400) and “Total Sell” (−1200), which is shown as the “CRSS Net Risk” (i.e., 1200). For each investor that has net risk in the opposite direction of the CRSS net risk (i.e., a negative amount since CRSS net risk is a positive value), which is Investor A, Investor C, and Investor E, the system spots, or spots and hedges, their trades at the implied mid, which is shown in column 203 titled “implied mid” and reproduced within the columns titled “CRSS Spot” 207 for each of Investors A, C, and E at the cells corresponding to the rows 202 and 204 titled “Buy” and “Sell” respectively. For each investor that has net risk in the same direction as the CRSS net risk (i.e., a positive net risk since the CRSS net risk is a positive value (1200)), which in this example are Investors B and D as shown in row title Investor Net Risk, the net risk to execute as the “umbrella hedge” is reduced proportionally, as shown within row 208 titled “Umbrella Net Risk” based on reduction of the CRSS risk after netting together investors' pools, which is the ratio of “Total Sell” (−1200) to “Total Buy” (2400) and shown as “Platform Ratio” (0.5). After the umbrella hedge is executed, the prices for the spots, or spots and hedges (which are linked), are calculated based on the price of the execution umbrella hedge and the price of where some risk was internalized at the “composite mid”, shown as “Move Ratio” (i.e., how far toward the mid the spot can go) corresponding to Investors B and D and resulting in the spot/hedge prices shown within the column 207 titled “CRSS Spot” for each of Investors B and D at the cells corresponding to row 202 titled “Buy”. The difference in traditional net spotting versus the spotting utilizing the CRSS transactions described herein can be seen by the difference in savings, shown for each Investor at rows 212 and 216 titled “Net Spot Savings” and “CRSS Savings” respectively, and the different spots shown for each investor in rows 202 and 204 titled “Buy” and “Sell” respectively within the columns 205 and 207 titled “Spot (Traditional)” and “CRSS Spot” respectively, or the summary spot prices shown for each Investor at rows 210 and 214 titled “Spot with Traditional Spotting” and “Spot with CRSS” respectively. As can be seen, while the traditional process results in savings for Investors A, C and E, it does not result in any savings for Investors B and D. However utilizing a CRSS transaction, every investor realizes savings. Accordingly, the CRSS process, unlike the traditional process, enables all investors to share in the savings regardless of whether they were only buying or only selling.

In further embodiments, risk of intermediating dealers is reduced by executing their trades at the mid-price if an intermediating dealer's Net Risk is in the opposite direction of the CRSS risk, or by proportionally distributing the intermediating dealer's Net Risk proportionally among the investor pools who also have Net Risk in the same direction of the CRSS risk.

In other embodiments spot prices are determined by using distinct pools of investor risk. To do so, the system calculates the Net Risk needed for each investor. Once clients are pooled, the system recalculates the Net Risk. An investor may have multiple trades within a CRSS transaction. The system may use various algorithms to pool clients together, including, but not limited to: (A) pooling all investors' risk into a single pool; (B) starting with the investor having the largest absolute risk, pooling other investors with them until the net risk would invert the pool's risk; (C) for the investor with the largest net risk, pooling investors that have Net Risk in the opposite direction until the net risk for that pool would be inverted in the other direction; (D) similar to C with the addition of checking before pooling that the absolute Net Risk for any given investor is not extended by being included in a specific pool; (E) iteratively and recursively taking the investor with the largest absolute net risk, and pooling them with the investor that has the smallest absolute net risk, and re-evaluating recursively; (F) similar to E with the addition of checking before pooling that the absolute Net Risk for any given investor is not extended by being included in a specific pool; or (G) iteratively and recursively, pooling together investors with the smallest net ratio (e.g., a net ratio of 0 meaning that all of an investor's trades are going in the same direction), and matching up against those with the smallest net ratio, and reinserting to recursively check that no client's ratio is ever reduced. When searching for a match the algorithm may need to match one client against multiple pools to ensure that that client's net ratio can be improved in cases where any single 1:1 match would otherwise reduce the clients' net ratio, but when taken together, the clients all benefit. After investors are pooled together, each pool is separately executed with its own umbrella hedge.

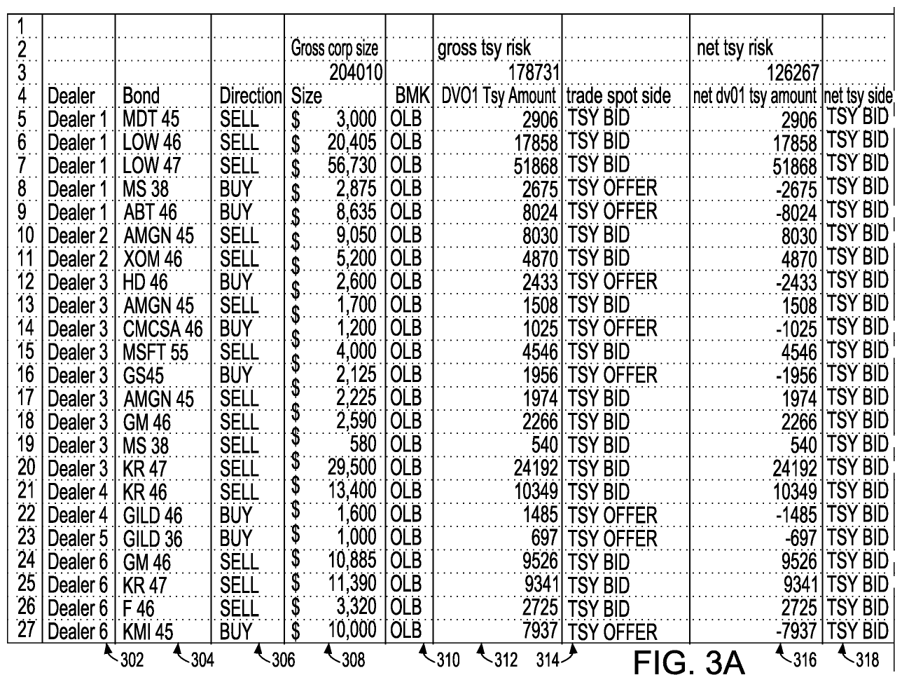

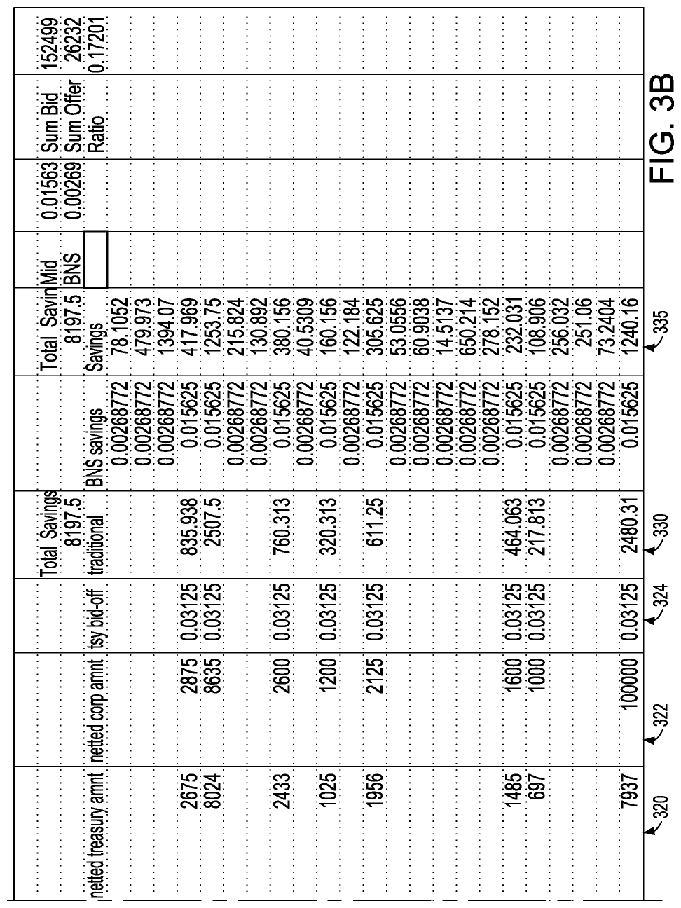

FIGS. 3A-3B illustrate exemplary savings realized using the above discussed system and method compared with traditional spotting models that tended to benefit those parties that are buying. All SQFP trades for an investor where each SQFP trade having a given treasury benchmark equivalent (i.e., 30 year), across all Dealers are shown in FIGS. 3A and 3B. The columns indicate the dealer name in column 302, the bond being traded in column 304, which side of the trade the dealer was on in column 306, the size of the trade in column 308, the benchmark in column 310, which in this particular example is an old long bond (“OLB”) (i.e., 30 year treasury), the DV01 treasury amount in column 312, which side of the spot that party is on in column 314, the Net DV01 Treasury amount in column 316, the Net Treasury side in column 318, the netted treasury amount in column 320, the netted corporate amount in column 322 and the treasury bid offer in column 324. Additionally, in column 330 entitled “traditional” the savings using a traditional spotting model is shown, while in column 335 entitled “savings” the saving pursuant to the embodiments discussed herein is shown. As can be seen in column 330 the savings under the traditional spotting method are only realized by the parties that are buying. However the savings pursuant to the embodiments discussed herein as seen in column 335 are distributed for the those that are buying and those that are selling. Initially the DV01-equivalent treasury hedge quantity is calculated by utilizing bond analytics pricing libraries, which handle all the variable type of bonds traded on the trading system, using market standard formula for DV01 as can be appreciated by one of ordinary skill in the art. For any trades that have been “netted”, the customer will not have to pay full Bid/Offer on those spots. The “Total Savings” reflects the amount of money saved by not paying full bid-offer on the spots of the netted trades.

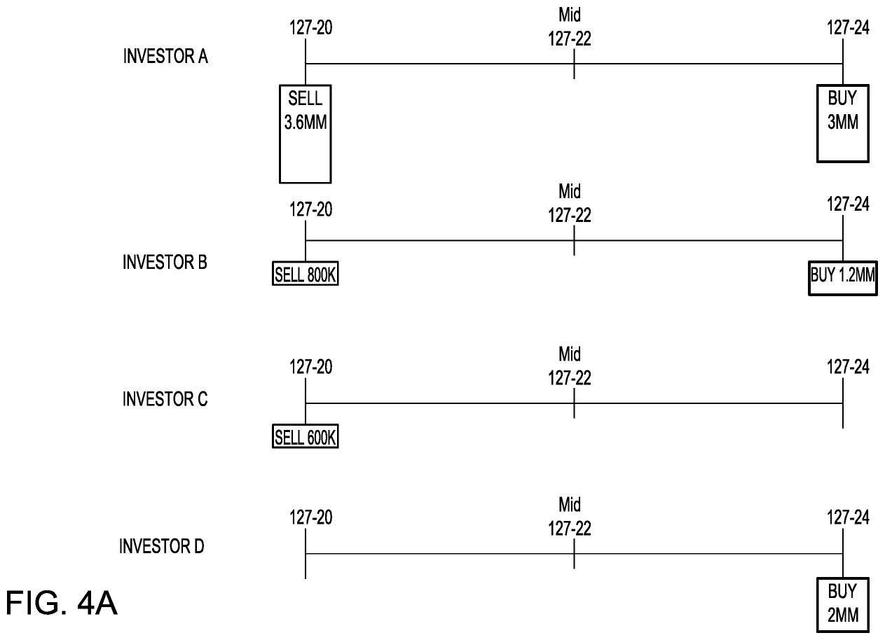

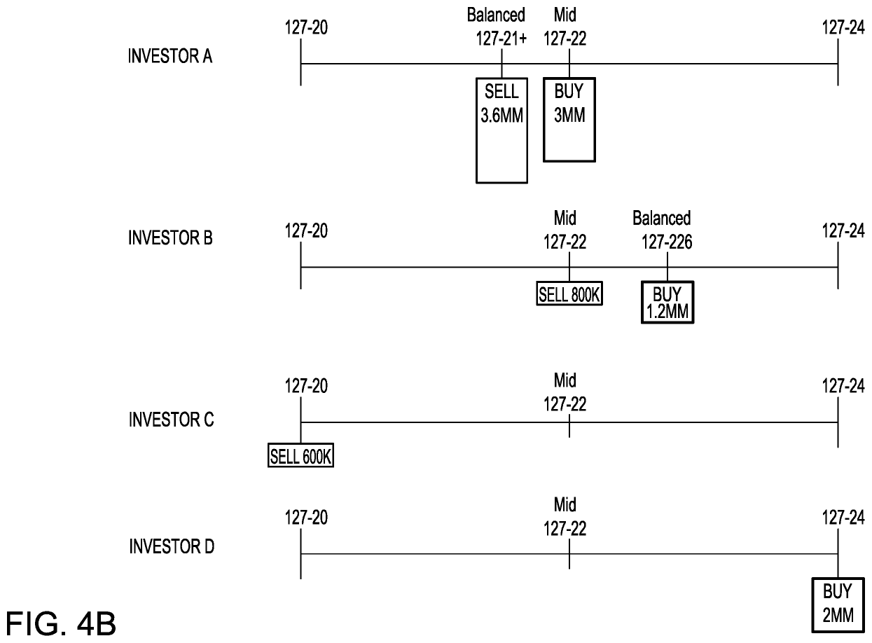

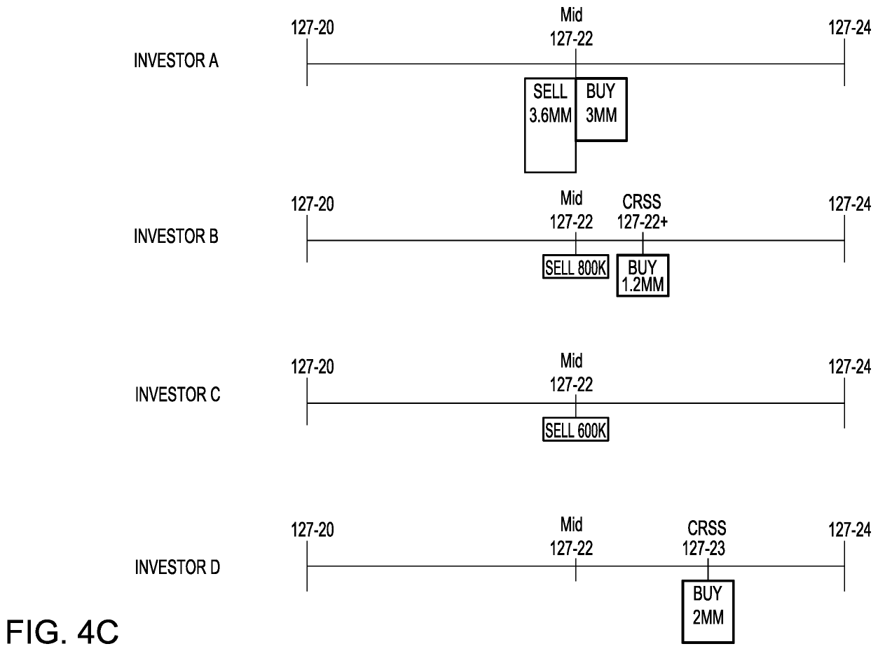

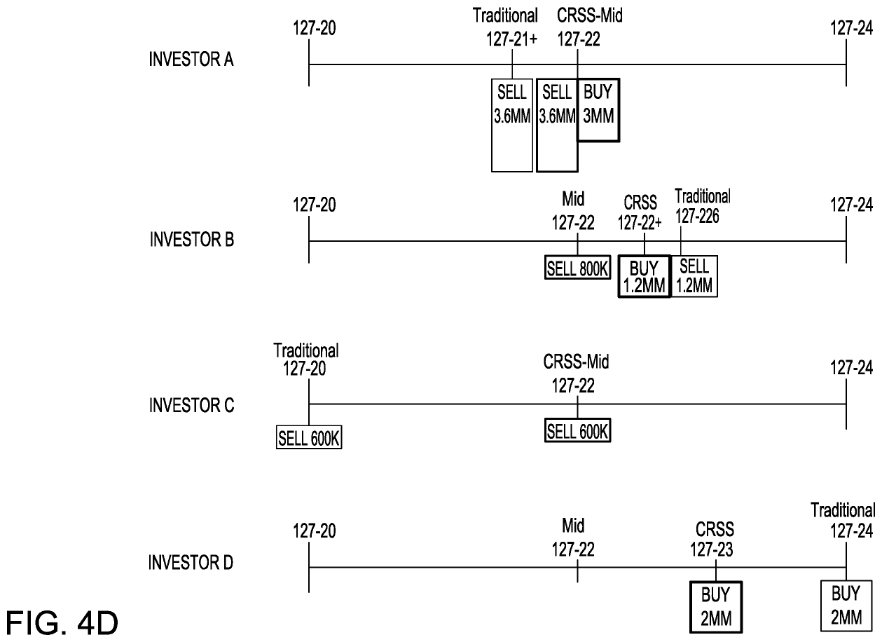

A further depiction of the pricing differentials between CRSS transactions and traditional spotting can be seen in FIGS. 4A-D. As shown in FIG. 4 there are four investors with differing buy and sell positions. Investor A has a 3.6 MM Sell position and a 3 MM Buy position. Investor B has an 800K Sell position and a 1.2 MM Buy position. Investor C has a 600 k Sell position and no Buy position. Investor D has a 2 MM Buy position with no Sell position. As can be seen in FIG. 4B, under the traditional spotting method, for Investor A and B who have both Buy and Sell positions, the lower position is automatically moved to the mid-price which in the example depicted in FIG. 4 is 127-22 (˜127.6875) and the other position is moved in a balanced manner from 127-20 (˜127.625) to 127-21+(˜127.671875) and from 127-24 (˜127.75) to 127.226 (˜127.710937575) respectively.

This results in spots that provide a benefit to Investors A and B who have both a Buy and Sell position, but not to Investors C and D who only have a single Buy or Sell position. As can be seen in FIG. 4C, for a CRSS transaction all investors, regardless of whether they have only sell and buy positions or whether they have both sell and buy positions benefit from multi spotting. Each of the Sell transactions, namely Investors A, B and C are transacted at the mid-price. The Buy position for Investor A is transacted at the mid-price, while the buy position for Investor C is transacted at a spot price of 127-22+(˜127.7031) and the buy position of Investor D is transacted at a spot price of 127-23 (˜127.7188). FIG. 4D shows a side by side comparison of the spot prices used under traditional spotting as opposed to a CRSS transaction in accordance with one embodiment of the present invention.

In certain embodiments, the API may be utilized by an investor to receive post trade messages for the purpose of automatically booking trades into the investor's system. Additionally, the API may also be utilized by the dealer to receive post trade message to facilitate automatic trade booking at the dealer site.

It should be noted that although the embodiments described may use multiple software modules for performing the various functions of the system, other embodiments could be implemented using any number of modules, with any single module incorporating the functions of several, or all, of the modules. The precise design of the software and the programming language used may be designed differently within the scope of the present invention. The software modules may be created using art recognized programming languages, including but not limited to C++, ASP, Java, C#, ASP.NET, or PHP or any combination of known or later developed programming languages that allow the functionality described.

Generally, the software functions of the computerized electronic trading system and method described herein may be programmed via application software, system software or any combination thereof, and may be executable on one or more hardware components within the system, external to the system or some combination thereof. In some embodiments, system and/or application level software may reside on system hardware, various external investor computer systems, or some combination thereof. For example, various embodiments may be implemented with a combination of application software (i.e., a dedicated software routine) which relies on system software (i.e., an operating system and disc drivers) stored on a mainframe computer. Alternately and/or additionally, the methods and systems described herein may include system software (i.e., an application programming interface) stored on an external investor computer system (i.e., via an API plugin) and used by an investor application and operating system, for example, to communicate information to other aspects of the computerized electronic trading system and method (i.e., an operating system) through a gateway connection.

Similarly, the implementation of various software functions described herein may at times overlap. In various embodiments, some software components may be stored in hardware residing within the system, external to the system or some combination thereof. For example, in some embodiments a software implementation may consist of a stand-alone application installed on a mainframe computer. In other embodiments, certain aspects may reside on investor hardware programmed to communicate with the trading system and method. Accordingly, the present invention should not be limited to the precise systems architecture described, but should be understood to include those variations as would be understood by a person of ordinary skill in the art having the benefits of the present disclosure.

It will also be understood that, although the various embodiments of the present invention described herein are being described in terms of web-based centralized server architecture, a thin client, fat client, or peer-to-peer type arrangement could be substituted for the system architecture described herein and are within the scope of the present invention. Additionally, the programming described herein may be stored in a machine readable form on a computer readable medium, such as a CD-ROM or DVD, and distributed to users for installation on user computers. Alternatively, such programming may be downloaded via network. In either embodiment, communication with the system may be effected across known networks, such as the Internet.

It should be noted that references herein to phrases such as “one embodiment” or “an embodiment” mean that a particular feature, structure or characteristic described in connection with the embodiment is included in at least one embodiment of the invention. The phrases such as “in one embodiment” or “in certain embodiments” in various places in the specification are not necessarily, but may be, referring to the same embodiment. Use of the term “preferred” or “preferably” is intended to indicate a configuration, set-up, feature, process, or alternative that may be perceived by the inventor(s) hereof, as of the filing date, to constitute the best, or at least a better, alternative to other such configurations, set-ups, features, processes, or alternatives. In no way shall the use of the term “preferred” or “preferably” be deemed to limit the scope of the claims hereof to any particular configuration, set-up, feature, process, or alternative.

It will be further appreciated by those skilled in the art that the figures are purely illustrative, and that the system may be implemented in any number of ways, by the actual designers, as long as the functionality as described above, stays intact.

While there have been shown and described fundamental novel features of the invention as applied to the exemplary embodiments thereof, it will be understood that omissions and substitutions and changes in the form and details of the disclosed invention may be made by those skilled in the art without departing from the broad inventive concept thereof. It is understood, therefore, that this invention is not limited to the particular embodiments disclosed, but it is intended to cover modifications within the spirit and scope of the present invention.

Moreover, numerous modifications and changes may readily occur to those skilled in the art. For example, various features and structures of the different embodiments discussed herein may be combined and interchanged. Hence, it is not desired to limit the invention to the exact construction and operation shown and described and, accordingly, all suitable modification equivalents may be resorted to falling within the scope of the invention as claimed. What is claimed is:

1. A computer implemented method of collapsing risk in connection with a plurality of electronic trades using a trading system comprising one or more computer systems, whereby the trading system is operative with programming to enable a plurality of market participants buying or selling financial products to execute and hedge the plurality of electronic trades, the method comprising:
collecting by the trading system electronic trades from each of the plurality of market participants, each electronic trade comprising data representing party information, data representing trade position information;
determining hedge amounts for buys and sells for the plurality of electronic trades based on the data representing trade information;
simultaneously determining by the trading system one or more net hedge amounts for each of the plurality of market participants;
simultaneously determining by the trading system a net hedge percentage for the plurality of electronic trades;
simultaneously determining by the trading system an individual hedge size for one or more first market participants from the plurality of market participants based on a unique umbrella hedge value, wherein the umbrella hedge value for each of the one or more first market participants is the net hedge percentage of said first market participant's net hedge amount; and
distributing by the trading system one or more instructions to the plurality of market participants to fill the plurality of electronic trades at one or more prices controlled by each first market participant's unique umbrella hedge value and by a composite mid-price for a plurality of second market participants from the plurality of market participants.

2. The method of claim 1 further comprising determining the one or more prices based at least in part on a weighted average related to a hedge value.

3. The method of claim 1 wherein at least one of the plurality of market participants has only buy positions.

4. The method of claim 1 wherein at least one of the plurality of market participants has only sell positions.

5. The method of claim 1 wherein at least one of the plurality of market participants has buy and sell positions.

6. The method of claim 1 wherein the plurality of market participants are grouped into pools of investors.

7. A non-transitory computer program product, comprising a computer usable medium having stored therein instructions that, when executed by at least one processor, configure one or more computers of an electronic trading system to:
collect by a trading system electronic trades from each of a plurality of market participants, each electronic trade comprising data representing party information, data representing trade position information;
determine by a trading system hedge amounts for buys and sells a plurality of electronic trades based on the data representing trade information;
determine by the trading system one or more net hedge amounts for each of the plurality of market participants;
determine by the trading system a net hedge percentage for the plurality of electronic trades;
determine by the trading system an individual hedge size for one or more first market participants from the plurality of market participants based on a unique umbrella hedge value, wherein the umbrella hedge value for each of the one or more first market participants is the net hedge percentage of said first market participant's net hedge amount; and
distribute by the trading system one or more instructions to the plurality of market participants to fill the plurality of electronic trades at one or more prices controlled by each first market participant's unique umbrella hedge value and by a composite mid-price for a plurality of second market participants from the plurality of market participants.

8. The non-transitory computer program product of claim 7 wherein the one or more prices based at least in part on a weighted average related to a hedge value.

9. The non-transitory computer program product of claim 7 wherein at least one of the plurality of market participants has only buy positions.

10. The non-transitory computer program product of claim 7 wherein at least one of the plurality of market participants has only sell positions.

11. The non-transitory computer program product of claim 7 wherein at least one of the plurality of market participants has buy and sell positions.

12. A computer implemented system for collapsing risk in connection with a plurality of electronic trades to enable a plurality of market participants buying or selling financial products to execute and hedge the plurality of electronic trades, the system comprising:
a trading system comprising one or more computer systems capable of analyzing a plurality of electronic trades and generating instructions including trade orders, the trading system further including one or more account database for storing data representing a plurality of electronic trades;
a plurality of user computers each in electronic communication with the trading system, the plurality of user computers including a plurality of dealer computers each comprising an automated dealer trading system capable of sending data to and receiving data from the trading system, and a plurality of market participant computers capable of sending data to and receiving data from the trading system;
wherein the trading system is communicatively coupled to the dealer computers, and the market participant computers, and the trading system is operative with programming to:
collect electronic trades from each of a plurality of market participants, each electronic trade comprising data representing party information, data representing trade position information;
determine hedge amounts for buys and sells a plurality of electronic trades based on the data representing trade information;
determine one or more net hedge amounts for each of the plurality of market participants;
determine a net hedge percentage for the plurality of electronic trades;
determine an individual hedge size for one or more first market participants from the plurality of market participants based on a unique umbrella hedge value, wherein the umbrella hedge value for each of the one or more first market participants is the net hedge percentage of said first market participant's net hedge amount; and
distribute one or more instructions to the plurality of market participants to fill the plurality of electronic trades at one or more prices controlled by each first market participant's unique umbrella hedge value and by a composite mid-price for a plurality of second market participants from the plurality of market participants.

13. The system of claim 12 wherein the one or more prices based at least in part on a weighted average related to a hedge value.

14. The system of claim 12 wherein at least one of the plurality of market participants has only buy positions.

15. The system of claim 12 wherein at least one of the plurality of market participants has only sell positions.

16. The system of claim 12 wherein at least one of the plurality of market participants has buy and sell positions.
